(19) United States
(12) Patent Application Publication
(10) Pub. No.: US 2020/0410964 A1
(43) Pub. Date: Dec. 31, 2020

(54) KEY ASSEMBLY AND KEYBOARD APPARATUS

(71) Applicant: YAMAHA CORPORATION, Hamamatsu-shi (JP)

(72) Inventors: Kento OGAWA, Funabashi-shi (JP); Ichiro OSUGA, Hamamatsu-shi (JP)

(21) Appl. No.: 17/018,352

(22) Filed: Sep. 11, 2020

Related U.S. Application Data
(63) Continuation of application No. PCT/JP2018/012051, filed on Mar. 26, 2018.

(51) Int. Cl. G10C 3/161; G10H 1/34; G10C 3/12

(52) U.S. Cl. CPC G10C 3/161; G10C 3/125; G10H 1/344

(57) ABSTRACT

A key assembly includes a capstan and a key. The key includes an upper surface, a hole part having a first inner side surface supporting the capstan, and an opening part arranged between the upper surface and the hole part, the opening part having a second inner side surface surrounding the capstan.

### CROSS REFERENCES TO RELATED APPLICATIONS

This application is based upon and claims the benefit of priority from the prior International Application PCT/JP2018/012051, filed on Mar. 26, 2018, the entire contents of which are incorporated herein by reference.

### FIELD

The present disclosure relates to a key used in a keyboard apparatus.

### BACKGROUND

Keyboard instruments are composed of many components, and an action mechanism arranged for each key is very complicated. In the keyboard instrument, the key pressing operation consists of the steps of rotating the key, moving the hammer through the action mechanism, and sounding by striking the string with the hammer. At this time, the key is rotated by the key pressing operation, and the action mechanism is driven by the capstan attached to the rear part of the key. The capstan is screw-type and the height of the capstan screw can be adjusted by turning the capstan screw. By adjusting the height of the capstan screw, the height of the hammer (the striking distance of the string) through the action mechanism can be adjusted.

The operation of the key, the action mechanism, and the hammer provides a sense of touch (hereinafter referred to as a touch feeling) to the player's fingers through the key. Therefore, the touch feeling of the key can be changed by adjusting the striking distance of the string by the capstan screw. Further, by adjusting the striking distance of the string of each keys of the keyboard instrument, the touch feeling of each key can be adjusted. The key, the action mechanism, and the hammer are mainly composed of woods, and the adjustments may be deviated due to environmental changes, aging changes, and the like. Even in such cases, the same touch feeling can be maintained at any time by adjusting the striking distance of the string by the capstan screw.

Japanese laid-open patent publication No. 2008-90167 discloses that a key of a keyboard instrument in which the mounting position of the capstan on the key body can be adjusted to any position of front-rear direction, thereby, the touch weight of the key can be adjusted in a wider range.

### SUMMARY

A key assembly according to one embodiment of the present disclosure includes a capstan, and a key including an upper surface, a hole part having a first inner side surface supporting the capstan, and an opening part arranged between the upper surface and the hole part, the opening part having a second inner side surface surrounding the capstan.

A key apparatus according to one embodiment of the present disclosure includes a key bed, a key assembly including a capstan and a key, the key assembly rotatably arranged with respect to the key bed, and an action mechanism mounted on the capstan. The key including an upper surface, a hole part having an inner side surface for supporting the capstan, and an opening part arranged between the upper surface and the hole part, the opening part having an inner side surface surrounding the capstan.

### BRIEF DESCRIPTION OF THE DRAWINGS

FIG. 1 is an enlarged view showing the vicinity of an action mechanism of a keyboard apparatus in one embodiment of the present disclosure;

FIG. 2 is a partial enlargement top view showing a fastening point of a capstan screw and a key in one embodiment of the present disclosure;

FIG. 3 is a partial enlargement cross-sectional view showing a fastening point of a capstan screw and a key in one embodiment of the present disclosure;

FIG. 4 is a partial enlargement cross-sectional view showing the capstan screw prior to fastening in one embodiment of the present disclosure;

FIG. 5 is a partial enlargement cross-sectional view showing the key prior to fastening in one embodiment of the present disclosure;

FIG. 6 is a partial enlargement top view showing a fastening point of a capstan screw and a key in one embodiment of the present disclosure;

FIG. 7 is a partial enlargement cross-sectional view showing a fastening point of a capstan screw and a key in one embodiment of the present disclosure;

FIG. 8 is a partial enlargement cross-sectional view showing the capstan screw prior to fastening in one embodiment of the present disclosure;

FIG. 9 is a partial enlargement cross-sectional view showing the key prior to fastening in one embodiment of the present disclosure;

FIG. 10 is a partial enlargement cross-sectional view showing a fastening point of a capstan screw and a key in one embodiment of the present disclosure;

FIG. 11 is a partial enlargement cross-sectional view showing the capstan screw prior to fastening in one embodiment of the present disclosure;

FIG. 12 is a partial enlargement cross-sectional view showing a fastening point of a capstan screw and a key in one embodiment of the present disclosure;

FIG. 13 is a partial enlargement cross-sectional view showing the capstan screw prior to fastening in one embodiment of the present disclosure;

FIG. 14 is a partial enlargement top view showing a fastening point of a capstan screw and a key in one embodiment of the present disclosure;

FIG. 15 is a partial enlargement cross-sectional view showing a fastening point of a capstan screw and a key in one embodiment of the present disclosure;

FIG. 16 is a partial enlargement cross-sectional view showing the capstan screw prior to fastening in one embodiment of the present disclosure;

FIG. 17 is a partial enlargement cross-sectional view showing the key prior to fastening in one embodiment of the present disclosure;

FIG. 18 is a partial enlargement cross-sectional view showing a fastening point of a capstan screw and a key in one embodiment of the present disclosure;

FIG. 19 is a partial enlargement cross-sectional view showing the capstan screw prior to fastening in one embodiment of the present disclosure;

FIG. 20 is a partially enlarged cross-sectional view showing a fastening point of a capstan screw and a key in a modified example of the present disclosure;

FIG. 21 is a partially enlarged cross-sectional view showing a fastening point of a capstan screw and a key in a modified example of the present disclosure; and

FIG. 22 is a partial enlargement cross-sectional view showing a fastening point of a capstan screw and a key in a modified example of the present disclosure.

### DESCRIPTION OF EMBODIMENTS

Hereinafter, a keyboard apparatus according to embodiments of the present disclosure will be described in detail by referring to the drawings. The following embodiments are examples of the embodiments of the present disclosure, and the present disclosure is not construed as being limited to these embodiments. In the drawings referred to in the present embodiments, the same portions or portions having similar functions are denoted by the same reference numerals or similar reference numerals (only A, B, etc. are denoted after numerals), and repetitive description thereof may be omitted. The dimensional ratios of the drawings (the ratio between the respective components and the ratio in the vertical and horizontal height directions, etc.), may be different from the actual ratios for convenience of description, or a part of the configurations may be omitted from the drawings.

The directions (the rotation direction R and the yawing direction Y) used in the following description will be defined. The rotation direction R corresponds to the rotation direction of the key 2. The yawing direction Y is a direction in which the key 2 bends in the left-right direction when viewed from above. The movement of key 2 in the yawing direction Y corresponds to bending (warping) in the scale direction S.

In Japanese laid-open patent publication No. 2008-90167, no consideration is given to suppress the deviation of the adjustment due to an environmental change and an aging change, etc. One of the objects of the present disclosure is to suppress the deviation of the adjustment and improve the reliability by suppressing an environmental change and an aging change of the key.

### First Embodiment

### [General Configuration of a Keyboard Apparatus]

In this embodiment, as an example of a keyboard apparatus, a grand piano having a keyboard on the front of which a plurality of keys to be performed by a player is arranged, will be described. However, the keyboard apparatus is not limited to this, and may be any keyboard apparatus driven by a key assembly having a key and a capstan screw, to be described later.

The plurality of keys includes white keys and black keys. The plurality of white keys and The plurality of black keys are arranged side by side. The number of keys is N, which we assumed to be 88. The direction in which a plurality of keys is arranged is referred to as a scale direction. Here, the white keys and the black keys will be referred to as key 2 in the case of being described without making a distinction.

### [Configuration of a Keyboard Assembly]

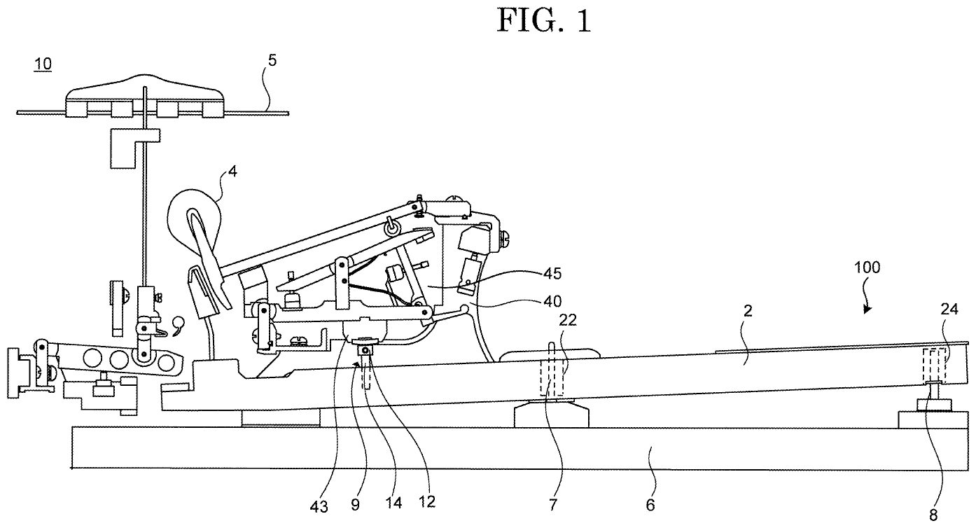

FIG. 1 is an enlarged view showing the vicinity of an action mechanism of a keyboard apparatus. In FIG. 1, the configuration arranged corresponding to each key 2 is shown with reference to the configuration arranged for one key 2 shown (in this example, the white key), and the configuration arranged for the other key 2 is omitted from the description.

In the descriptions of the present specification, the directions such as upward, downward, leftward, rightward, frontward, and rearward indicate the directions when the keyboard apparatus is viewed by the player during performance. In some cases, the directions may be indicated with respect to the key 2 as a reference, such as a front end side of the key (key front side) and a rear end side of the key (key rear side). In this case, the front end side of the key indicates the frontward of the key 2 as seen from the player. The rear end side of the key indicates the rearward of the key 2 as seen from the player.

As shown in FIG. 1, a keyboard assembly 10 is arranged in the keyboard apparatus. The keyboard assembly 10 includes a key assembly 100 including key 2, an action mechanism 45, a hammer 4, and a key bed 6. The keyboard assembly 10 is mostly a wooden construction. The key bed 6 is fixed at the housing of the keyboard apparatus. The key bed 6 has a balance pin 7. The balance pin 7 of the key bed 6 rotatably connects the key assembly 100 to the key bed 6. The balance pin 7 provides a fulcrum for supporting the key assembly 100 almost at the center of the direction in which the key 2 extends. Therefore, the key assembly 100 rotates around the balance pin 7 as a fulcrum with respect to the key bed 6 by the key pressing operation of the key 2.

The key assembly 100 has a capstan screw 9 at the rear end side of the fulcrum (the position supported by the balance pin 7) of the key 2. The capstan screw 9 is a metallic construction. The capstan screw 9 includes a head part 12 and a shaft part 14. The shaft part 14 of the capstan screw 9 is fastened to the top side of the key 2, and the head part 12 of the capstan screw 9 is arranged above the key 2. In other words, the head part 12 of the capstan screw 9 protrudes above the key 2. The configuration of the fastening points of the capstan screw 9 and the key 2 will be described in detail later.

On the top of the key assembly 100, the action mechanism 45 and the hammer 4 are arranged rotatably with respect to the frame 40. The action mechanism 45 and the hammer 4 are arranged corresponding to the key assembly 100. The support heel 43 arranged on the lower surface of the action mechanism 45 is slidably in contacts with the upper surface of the capstan screw 9 of the key assembly 100. This sliding part, i.e. the part where the support heel 43 of the action mechanism 45 and the capstan screw 9 of the key assembly 100 contact, is arranged backward from the fulcrum (the position supported by the balance pin 7) of the key 2 and above the key 2.

In the normal state (when the key is not pressed), the action mechanism 45 is placed above the capstan screw 9 of the key assembly 100, and the front end of the key 2 is pushed up. When the front end of the key 2 is depressed, the key assembly 100 rotates around the fulcrum, and the capstan screw 9 moves the hammer 4 upward through the action mechanism 45. As a result, the hammer 4 hits the string 5 arranged corresponding to the key assembly 100. The string 5 has a vibrational frequency corresponding to each key assembly 100 and emits sound by the impact of the hammer 4. When the key 2 is released, the key assembly 100 rotates around the fulcrum and returns to its original position, and moves the action mechanism 45 and the hammer 4 downwardly. The capstan screw 9 is defined as the position at which the action mechanism 45 is driven and the key 2 is loaded.

### [Configuration of a Fastening Point of a Capstan Screw and a Key]

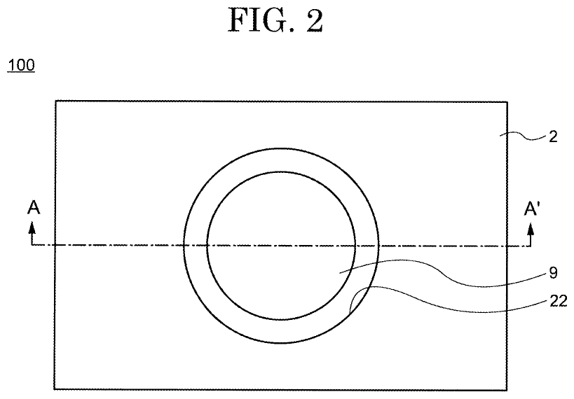

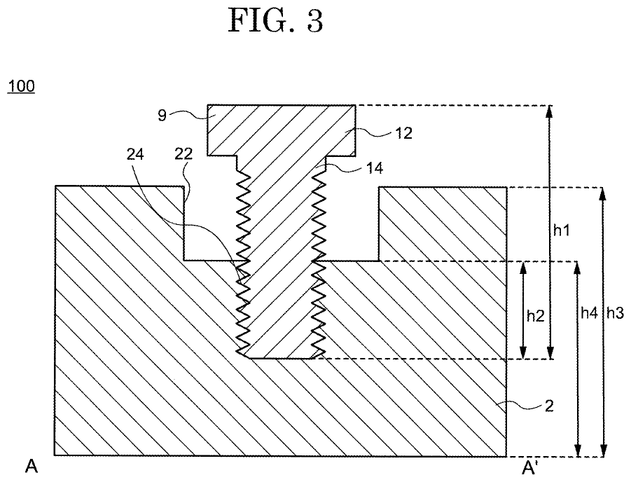

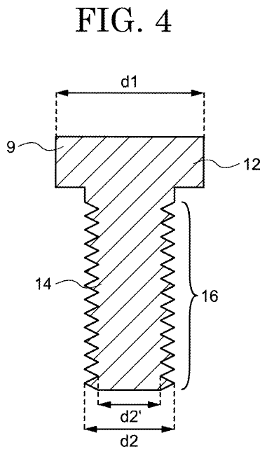

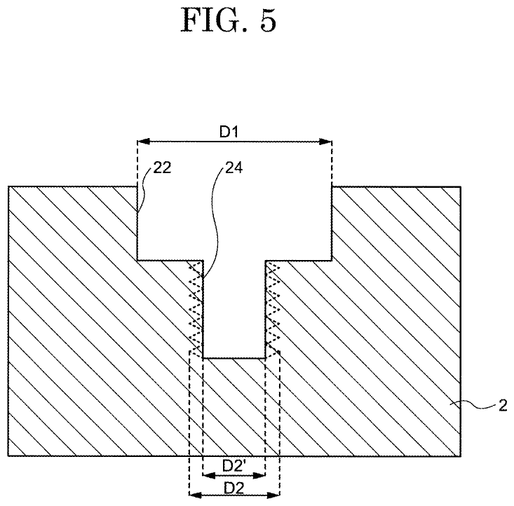

A configuration of a fastening point of a capstan screw and a key will be described in detail with reference to FIGS. 2 to 5. FIG. 2 is a partial enlarged top view of a fastening point of a capstan screw and a key according to an embodiment of the present disclosure. FIG. 3 is a partial enlarged cross-sectional view of the fastening point of the capstan screw and the key according to an embodiment of the present disclosure. FIG. 4 is a partial enlargement cross-sectional view of the capstan screw prior to fastening in one embodiment. FIG. 5 is a partial enlargement cross-sectional view of the key prior to fastening in one embodiment.

The capstan screw 9 includes a head part 12 and a shaft part 14. In this embodiment, the shaft part 14 has a screw part 16. The screw part 16 of the capstan screw 9 is fastened to the hole part 24 of the key 2. The diameter d1 of the head part 12 is larger than the diameter d2 of the screw part 16. Here, the diameter d1 of the head part 12 indicates the maximum diameter of the head part 12 as seen in the axial direction, the diameter d2 of the screw part 16 indicates the maximum diameter of the screw part 16 as seen in the axial direction. Since the diameter d1 of the head part 12 of the capstan screw 9 is larger than the diameter d2 of the screw part 16, the action mechanism 45 can be mounted stably on the capstan screw 9, and the action mechanism 45 can be slid stably on the capstan screw 9 in accordance with the pressing and releasing operation of the key. In this embodiment, the head part 12 and the shaft part 14 as seen from the top surface are circular. The center of the head part 12 is almost coincident with the center of the shaft part 14 as seen from the top surface. However, the present disclosure is not limited thereto, and the head part 12 may be a polygonal, for example, and the center of the head part 12 and the center of the shaft part 14 may misaligned each other.

The key 2 includes an opening part 22 and a hole part 24 having an inner side surface for supporting the capstan screw 9 on the upper surface (the surface to be pressed). Here, the hole part 24 is arranged at the bottom of the opening part 22. That is, the opening part 22 is arranged at a upper surface side of the key 2 than the hole part 24. The opening part 22 and the hole part 24 are continuous in the direction of rotation of the key assembly 100. Since the hole part 24 for supporting the capstan screw 9 is arranged at the bottom of the opening part 22, the width of the key 2 around the region on which the capstan screw 9 is supported in the direction of rotation of the key 2 that is subject to the environmental changes and the aging changes is reduced from h3 to h4. Therefore, if the amount of change in the rotation direction of the key 2 is the same rate, the amount of change in the axial direction that the capstan screw 9 receives from the key 2 is suppressed to h4/h3. By arranging the hole part 24 on which the capstan screw 9 is supported at the bottom of the opening part 22, the effect of the capstan screw 9 subjected in the rotational directions of the key 2 due to the environmental changes and aging changes can be suppressed. Therefore, the key assembly 100 can suppress the deviation of the adjustment.

The inner side surface of the opening part 22 and the inner side surface of the hole part 24 are both arranged so as to surround the capstan screw 9. In other words, the opening part 22 and the hole part 24 are bores that are closed other than the rotatable orientation of the key assembly 100. Therefore, the width of the opening part 22 in the scale direction is smaller than the width of the key 2 in the scale direction. Since the opening part 22 is arranged so as to surround the capstan screw 9, a large part of the key 2 can maintain the width h3 in the rotational direction. Therefore, the key 2 can maintain sufficient strength even if the key 2 has the opening part 22, and the key assembly 100 can maintain the reliability.

In this embodiment, the opening part 22 and the hole part 24 as seen from the top surface are circular. The center of the opening part 22 is almost coincident with the center of the hole part 24 as seen from the top surface. However, the present disclosure is not limited thereto, and the opening part 22 may be a polygonal, for example, and the center of the opening part 22 and the center of the hole part 24 may misaligned each other. In this embodiment, the diameter D1 of the opening part 22 is larger than the diameter D2 of the hole part 24. Here, the diameter D1 of the opening part 22 indicate the maximum diameter of the opening part 22 as seen from the top surface, the diameter D2 of the hole part 24 indicate the maximum diameter of the hole part 24 as seen from the top surface.

In this embodiment, the screw part 16 of the capstan screw 9 is spaced from the inner side surface of the opening part 22. The diameter D1 of the opening part 22 is larger than the maximum diameter d2 of the screw part 16.

The head part 12 of the capstan screw 9 is arranged outside the opening part 22. That is, the head part 12 of the capstan screw 9 protrudes to the upper surface side of the key 2. In this embodiment, the diameter d1 of the head part 12 of the capstan screw 9 is smaller than the diameter D1 of the opening part 22. However, the diameter of the head part 12 of the capstan screw 9 may be larger than the diameter of the opening part 22.

The screw part 16 of the capstan screw 9 engages the inner side surface of the hole part 24. Thus, the maximum diameter d2 of the screw part 16 (the diameter between the peaks cutting edge of a male screw) and the maximum diameter D2 of the hole part 24 (the diameter between the valleys cutting edge of a female screw) are almost same. The minimum diameter d2′ of the screw part 16 (the diameter between the valleys cutting edge of a male screw) and the minimum diameter D2′ of the hole part 24 (the diameter between the peaks cutting edge of a female screw) are almost the same. As shown in FIG. 5, the hole part 24 prior to fastening the capstan screw 9 is a prepared hole which has not been internally threaded. Therefore, the maximum diameter of the hole part 24 prior to fastening the capstan screw 9 is almost the same as the minimum diameter d2′ of the screw part 16. As shown by the dotted line in FIG. 5, the hole part 24 is internally threaded by fastening the capstan screw 9, and the maximum diameter D2 of the hole part 24 is almost the same as the maximum diameter d2 of the screw part 16. However, the present disclosure is not limited thereto, and if the tip portion of the capstan screw 9 is sharp, the diameter of the prepared hole may be smaller than the minimum diameter d2′ of the screw part 16, or the prepared hole may not be provided. In the present embodiment, the screw part 16 and the hole part 24 as seen from the top surface is circular. The outer surface of the screw part 16 engages with the inner side surface of the hole part 24 in almost the entire circumferential direction. However, the present disclosure is not limited thereto, and the screw part 16 or the hole part 24 may be, for example, a polygonal, as long as the screw part 16 and the hole part 24 as seen from the top surface are engaged at least at three points.

As described above, according to the key assembly 100 of the present embodiment, since the hole part 24 is arranged at the bottom of the opening part 22, the effect of the capstan screw 9 subjected in the rotational directions of the key 2 due to the environmental changes and aging changes can be suppressed. The opening part 22 is arranged so as to surround the capstan screw 9, whereby the strength of the key 2 can be maintained. Therefore, the key assembly 100 can suppress the deviation of the adjustment and maintain reliability.

### Second Embodiment

In the second embodiment, a key assembly 100a having a configuration differing from that of the key assembly 100 in the first embodiment will be described. A key 2a of the second embodiment is different from the key 2 of the first embodiment in that the diameter D1a of the opening part 22a is almost the same as the maximum diameter d2a of the screw part 16a. The capstan screw 9a of the second embodiment is the same as the capstan screw 9 of the first embodiment. In the key assembly 100a of the second embodiment, the opening part 22a of the key 2a and the screw part 16a of the capstan screw 9a partially contact each other. The same parts as those in the first embodiment are given the same numbers as those of the previous description, and repeated descriptions will be omitted.

### [Configuration of a Fastening Points of a Capstan Screw and a Key]

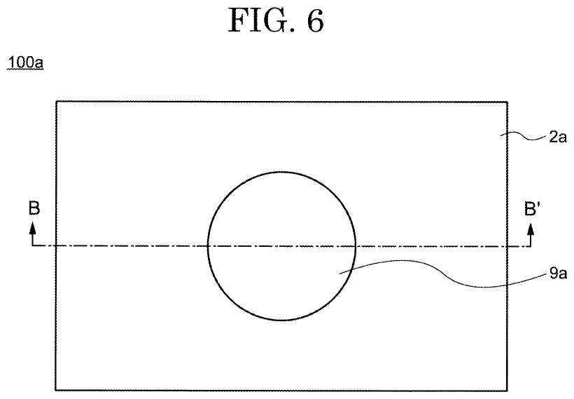

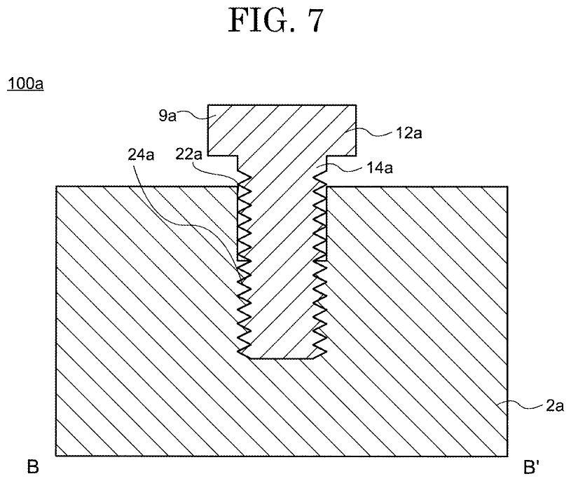

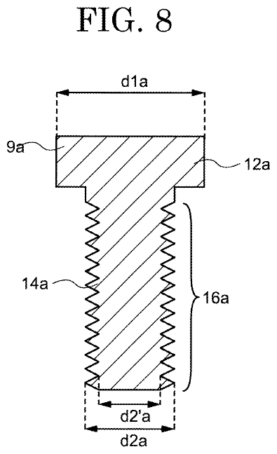

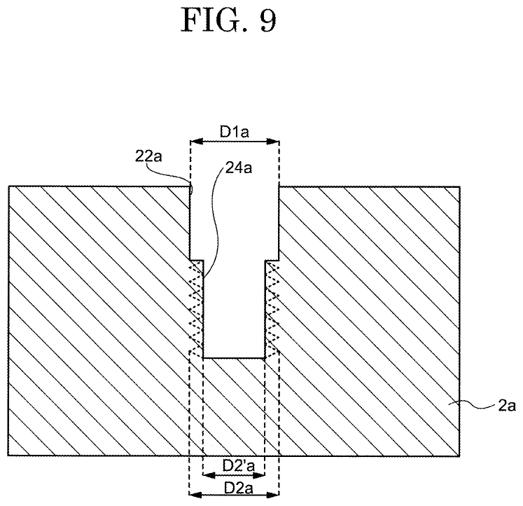

A configuration of a fastening point of a capstan screw and a key will be described in detail with reference to FIGS. 6 to 9. FIG. 6 is a partial enlarged top view of a fastening point of the capstan screw and the key according to an embodiment of the present disclosure. FIG. 7 is a partial enlargement cross-sectional view of the fastening point of the capstan screw and the key according to an embodiment of the present disclosure. FIG. 8 is a partial enlargement cross-sectional view of the capstan screw prior to fastening in one embodiment. FIG. 9 is a partial enlargement cross-sectional view of the key prior to fastening in one embodiment.

The Key 2 includes an opening part 22a and a hole part 24a having an inner side surface for supporting the capstan screw 9a on the upper surface (the surface to be pressed). Here, the hole part 24a is arranged at the bottom of the opening part 22a. That is, the opening part 22a is arranged on the upper surface side of the key 2a than the hole part 24a. The opening part 22a and the hole part 24a are continuous with each other in the directions of rotation of the key assembly 100a. The inner side surface of the opening part 22a and the inner side surface of the hole part 24a are both arranged so as to surround the capstan screw 9a. Since the hole part 24a for supporting the capstan screw 9a is arranged at the bottom of the opening part 22a, the effect of the capstan screw 9a subjected in the rotational directions of the key 2a due to the environmental changes and aging changes can be suppressed. The strength of the key 2a can be maintained by arranging the opening part 22a so as to surround the capstan screw 9a. Therefore, the key assembly 100a can suppress the deviation of the adjustment and maintain the reliability.

In this embodiment, the diameter D1a of the opening part 22a is almost the same as the diameter D2a of the hole part 24a. The diameter D1a of the opening part 22a is almost the same as the diameter d2a of the screw part 16a. For this reason, the inner side surface of the opening part 22a is in contacts with the top of the thread of the screw part 16a. Since the diameter D1a of the opening part 22a is almost the same as the diameter D2a of the hole part 24a, the strength of the key 2a can be improved. The capstan screw 9a and the key 2a can be stably fastened by contacting the inner side surface of the opening part 22a and the top of the thread of the screw part 16a.

The head part 12a of the capstan screw 9a is arranged outside of the opening part 22a. That is, the head part 12a of the capstan screw 9a protrudes to the upper surface side (the surface to be pressed) of the key 2a. In this embodiment, the diameter d1a of the head part 12a of the capstan screw 9a is larger than the diameter D1a of the opening part 22a.

The screw part 16a of the capstan screw 9a engages the inner side surface of the hole part 24a. Thus, maximum diameter d2a of the screw part 16a and maximum diameter D2a of the hole part 24a are almost the same, and minimum diameter d2′a of the screw part 16a and minimum diameter D2′a of the hole part 24a are almost the same. As shown in FIG. 9, the hole part 24a prior to fastening the capstan screw 9a is a prepared hole which has not been internally threaded. Therefore, the maximum diameter of the hole part 24a prior to fastening the capstan screw 9a and minimum diameter d2′a of the screw part 16a is almost the same. The maximum diameter D2′a of the hole part 24a prior to fastening the capstan screw 9a is smaller than the maximum diameter D1a of the opening part 22a. As shown by the dotted line in FIG. 9, the hole part 24a is internally threaded by fastening the capstan screw 9a, and the maximum diameter D2a of the hole portion 24a is almost the same as the maximum diameter d2a of the screw portion 16a. The diameter D2a of the hole part 24a is almost the same as the diameter D1a of the opening part 22a.

As described above, according to the key assembly 100a of the present embodiment, since the hole part 24a is arranged at the bottom of the opening part 22a, the effect of the capstan screw 9a subjected in the rotational directions of the key 2a due to the environmental change and the aging change can be suppressed. The opening part 22a is arranged so as to be in contact with the capstan screw 9a, whereby the capstan screw 9a and the key 2a can be stably fastened while the strength of the key 2a is improved. Therefore, the key assembly 100a can suppress the deviation of the adjustment and improve reliability.

### Third Embodiment

The capstan screw 9b of the third embodiment is different from the capstan screw 9a of the second embodiment in that the shaft part 14b has a screw part 16b and a cylinder part 18b. The key 2b of the third embodiment is the same as the key 2a of the second embodiment. In the key assembly 100b of the third embodiment, the opening part 22b of the key 2b and the cylinder part 18b of the capstan screw 9b are in contact with each other. The same parts as those of the first embodiment and the second embodiment are given the same numerals as those of the previous description, and repeated descriptions will be omitted.

### [Configuration of a Fastening Points of a Capstan Screw and a Key]

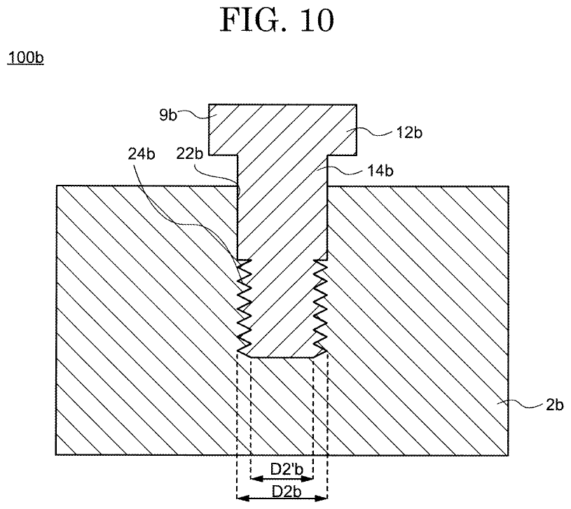

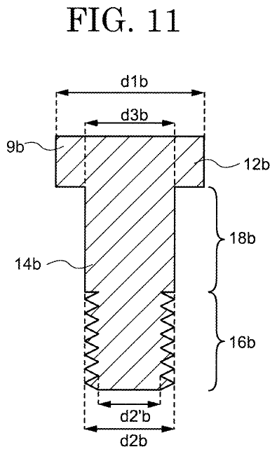

A configuration of a fastening point of a capstan screw and a key will be described in detail with reference to FIGS. 10 and 11. FIG. 10 is a partial enlargement cross-sectional view of the fastening point of the capstan screw and the key according to an embodiment of the present disclosure. FIG. 11 is a partial enlargement cross-sectional view of the capstan screw prior to fastening in one embodiment. Here, a partial enlarged top view of the fastening point of the capstan screw and the key and a partial enlarged cross-sectional view of the key prior to fastening are the same as those in the second embodiment, and therefore will not be described.

The capstan screw 9b has a head part 12b and a shaft part 14b. In this embodiment, the shaft part 14b has a screw part 16b and a cylinder part 18b. The screw part 16b of the capstan screw 9b is fastened to the hole part 24b of the key 2b. In FIG. 10, the screw part 16b are all located in the hole part 24b. However, the present disclosure is not limited thereto, and a part of the screw part 16b may be arranged in the opening part 22b. In this instance, a part of the hole part 24b may have a space in which the screw part 16b is not arranged. The diameter d3b of the cylinder part 18b and the diameter d2b of the screw part 16b are almost the same. Here, the diameter d3b of the cylinder part 18b shows the maximum diameter of the cylinder part 18b as seen in the axial direction, the diameter d2b of the screw part 16b shows the maximum diameter of the screw part 16b as seen in the axial direction. In this embodiment, the cylinder part 18b and the shaft part 14b as seen from the top surface is circular. The center of the cylinder part 18b is almost coincident with the center of the shaft part 14b as seen from the top surface. However, the present disclosure is not limited thereto, and the cylinder part 18b may have a polygonal shape, for example.

The key 2b includes an opening part 22b and a hole part 24b having an inner side surface for supporting the capstan screw 9b on its upper surface (the surface to be pressed). Here, the hole part 24b is arranged at the bottom of the opening part 22b. That is, the opening part 22b is arranged at the upper surface side of the key 2b than the hole part 24b. The opening part 22b and the hole part 24b are continuous in the direction of rotation of the key assembly 100b. The inner side surface of the opening part 22b and the inner side surface of the hole part 24b are both arranged to surround the capstan screw 9b. Since the hole part 24b for supporting the capstan screw 9b is arranged at the bottom of the opening part 22b, the effect of the capstan screw 9b subject in the rotational directions of the key 2b due to the environmental changes and aging changes can be suppressed. The strength of the key 2b can be maintained by arranging the opening part 22b so as to surround the capstan screw 9b. Therefore, the key assembly 100b can suppress the deviation of the adjustment and maintain the reliability.

In this embodiment, the diameter D1b of the opening part 22b is almost the same as the diameter D2b of the hole part 24b. The diameter D1b of the opening part 22b is almost the same as the diameter d3b of the cylinder part 18b. Therefore, the inner side surface of the opening part 22b is contact with the outer surface of the cylinder part 18b. Since the diameter D1b of the opening part 22 b is almost the same as the diameter D2b of the hole part 24b, the strength of the key 2b can be improved. The capstan screw 9b and the key 2b can be stably fastened by contacting the inner side surface of the opening part 22b and the outer surface of the cylinder part 18b.

As described above, according to the key assembly 100b of the present embodiment, since the hole part 24b is arranged at the bottom of the opening part 22b, the effect of the capstan screw 9b subjected in the rotational directions of the key 2b due to the environmental changes and the aging changes can be suppressed. The opening part 22b is arranged so as to be in contact with the capstan screw 9b, whereby the capstan screw 9b and the key 2b can be stably fastened while the strength of the key 2b is improved. For this reason, the key assembly 100b can suppress deviation of the adjustment and further improve the reliability.

### Fourth Embodiment

The capstan screw 9c of the fourth embodiment is different from the capstan screw 9b of the third embodiment in that the diameter d3c of the cylinder part 18c is smaller than the diameter d2c of the screw part 16c. The key 2c of the fourth embodiment is the same as the key 2b of the third embodiment. The same parts as those of the first to third embodiments are given the same numerals as those of the previous description, and repeated descriptions will be omitted.

### [Configuration of a Fastening Points of a Capstan Screw and a Key]

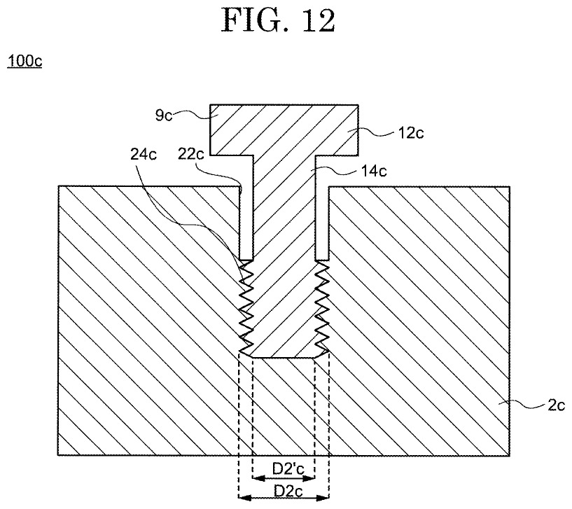

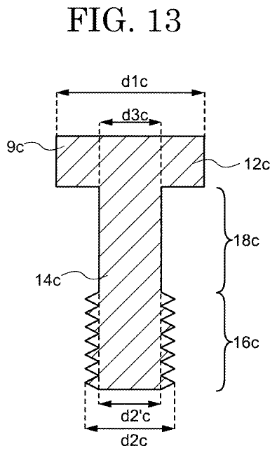

A configuration of a fastening point of a capstan screw and a key will be described in detail with reference to FIGS. 12 and 13. FIG. 12 is a partial enlargement cross-sectional view of the fastening point of the capstan screw and the key according to an embodiment of the present disclosure. FIG. 13 is a partial enlargement cross-sectional view of the capstan screw prior to fastening in one embodiment. Here, a partial enlarged top view of the fastening point of the capstan screw and the key and a partial enlarged cross-sectional view of the key prior to fastening are the same as those in the second embodiment, and therefore will not be described.

The capstan screw 9c has a head part 12c and a shaft part 14c. In this embodiment, the shaft part 14c has a screw part 16c and a cylinder part 18c. The screw part 16c of the capstan screw 9c is fastened to the hole part 24c of the key 2c. In FIG. 12, the screw part 16c are all placed in the hole part 24c. However, the present disclosure is not limited thereto, a part of the screw part 16c may be arranged in the opening part 22c. In this instance, a part of the hole part 24c may have a space in which screw the part 16c is not arranged. The diameter d3c of the cylinder part 18c is smaller than the diameter d2c of the screw part 16c.

The key 2c includes an opening part 22c and a hole part 24c having an inner side surface for supporting the capstan screw 9c on its upper surface (the surface to be pressed). The hole part 24c is arranged at the bottom of the opening part 22c. That is, the opening part 22c is arranged at the upper surface side of the key 2c with respect to the hole part 24c. The opening part 22c and the hole part 24c are continuous in the direction of rotation of the key assembly 100c. The inner side surface of the opening part 22c and the inner side surface of the hole part 24c are both arranged to surround the capstan screw 9c. Since the hole part 24c for supporting the capstan screw 9c is arranged at the bottom of the opening part 22c, the effect of the capstan screw 9c subject in the rotational directions of the key 2c due to the environmental changes and aging changes can be suppressed. The strength of the key 2c can be maintained by arranging the opening part 22c so as to surround the capstan screw 9c. Therefore, the key assembly 100c can suppress the deviation of the adjustment and maintain the reliability.

In this embodiment, the diameter D1c of the opening part 22c is almost the same as the diameter D2c of the hole part 24c. Since the diameter D1c of the opening part 22c is almost the same as the diameter D2c of the hole part 24c, the strength of the key 2c can be improved. The cylinder part 18c of the capstan screw 9c is separated from the inner side surface of the opening part 22c. The diameter D1c of the opening part 22c is larger than the maximum diameter d3c of the cylinder part 18c.

As described above, according to the key assembly 100c of the present embodiment, since the hole part 24c is arranged at the bottom of the opening part 22c, the effect of the capstan screw 9c subjected in the rotational directions of the key 2c due to the environmental change and the aging change can be suppressed. The strength of the key 2c can be maintained by arranging the opening part 22c so as to surround the capstan screw 9c. Therefore, the key assembly 100c can suppress the deviation of the adjustment and improve reliability.

### Fifth Embodiment

The key 2d of the fifth embodiment is different from the key 2c of the fourth embodiment in the configuration of the opening part 22d. The capstan screw 9d of the fifth embodiment is the same as the capstan screw 9c of the fourth embodiment. In the key assembly 100d of the fifth embodiment, the opening part 22d of the key 2d and the cylinder part 18d of the capstan screw 9d partially contact each other. The same parts as those of the first to fourth embodiments are given the same numerals as those of the previous description, and repeated descriptions will be omitted.

### [Configuration of a Fastening Points of a Capstan Screw and a Key]

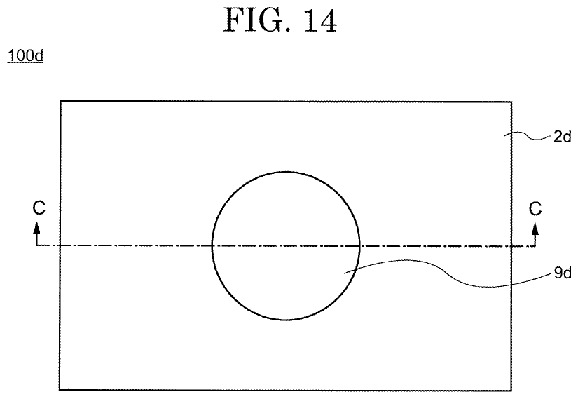

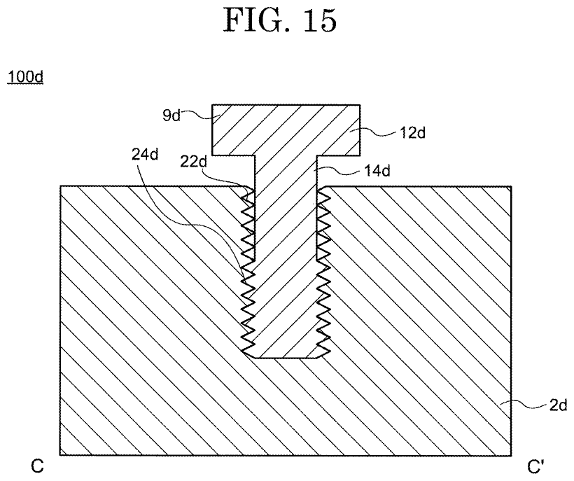

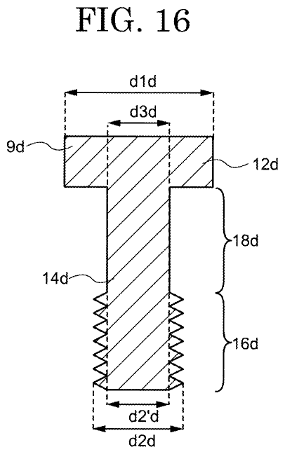

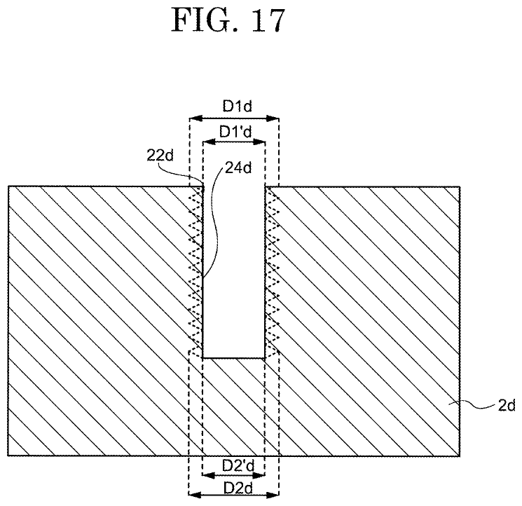

A configuration of a fastening point of a capstan screw and a key will be described in detail with reference to FIGS. 14 to 17. FIG. 14 is a partial enlargement top view of a fastening point of the capstan screw and the key according to an embodiment of the present disclosure. FIG. 15 is a partial enlarged cross-sectional view of a fastening point of the capstan screw and the key according to an embodiment of the present disclosure. FIG. 16 is a partial enlargement cross-sectional view of the capstan screw prior to fastening in one embodiment. FIG. 17 is a partial enlargement cross-sectional view of the key prior to fastening in one embodiment.

The key 2d includes an opening part 22d and a hole part 24d having an inner side surface for supporting the capstan screw 9d on its upper surface (the surface to be pressed). The hole part 24d is arranged at the bottom of the opening part 22d. That is, opening part 22d is arranged at the upper surface side of the key 2d with respect to the hole part 24d. The opening part 22d and the hole part 24d are continuous in the direction of rotation of the key assembly 100d. The inner side surface of the opening part 22d and inner side surface of hole part 24d are both arranged to surround the capstan screw 9d. Since the hole part 24d on which the capstan screw 9d is supported is arranged at the bottom of the opening part 22d, the effect of the capstan screw 9d subject in the rotational directions of the key 2d due to the environmental changes and aging changes can be suppressed. The strength of the key 2d can be maintained by arranging the opening part 22d so as to surround the capstan screw 9d. Therefore, the key assembly 100d can suppress the deviation of the adjustment and maintain reliability.

In this embodiment, the shape of the opening part 22d is almost the same as the shape of the hole part 24d, and thread is cut. The maximum diameter D1d of the opening part 22d is almost the same to the maximum diameter D2d of the hole part 24d. The minimum diameter D1′d of the opening part 22d is almost same to the minimum diameter D2′d of the hole part 24d. Furthermore, the maximum diameter D1d of the opening part 22d and the maximum diameter D2d of the hole part 24d is almost same to the maximum diameter d2d of the screw part 16d. The minimum diameter D1′d of the opening part 22d and the minimum diameter D2′d of the hole part 24d are almost same to the minimum diameter d2′d of the screw part 16d. The minimum diameter D1′d of the opening part 22d and the minimum diameter D2′d of the hole part 24d are almost the same as the maximum diameter d3d of the cylinder part 18d. For this reason, the top of the thread of the opening part 22d (female thread having the minimum diameter D1′d) is in contacts with the outer surface of the cylinder part 18d. Since the maximum diameter D1d of the opening part 22d is almost the same as the maximum diameter D2d of the hole part 24d, the strength of the key 2d can be improved. The capstan screw 9d and the key 2d can be stably fastened by contacting the top of the threads of the opening part 22d and the outer surface of the cylinder part 18d.

The screw part 16d of the capstan screw 9d engages the inner side surface of the hole part 24d. As shown in FIG. 17, the opening part 22d and the hole part 24d prior to fastening the capstan screw 9d are prepared holes which has not been internally threaded. Therefore, the maximum diameter of the opening part 22d prior to fastening the capstan screw 9d and the maximum diameter D2′d of the hole part 24d are almost same to the minimum diameter d2′d of the screw part 16d. As shown by the dotted line in FIG. 17, the opening part 22d and the hole part 24d are internally threaded by fastening the capstan screw 9d, and the maximum diameter D1d of the opening part 22d, the maximum diameter D2d of the hole part 24d, and the maximum diameter d2d of the screw part 16d are almost the same.

As described above, according to the key assembly 100d of the present embodiment, since the hole part 24d is arranged at the bottom of the opening part 22d, the effect of the capstan screw 9d subjected in the rotation directions of the key 2d due to the environmental changes and aging changes can be suppressed. The capstan screw 9d and the key 2d can be stably fastened while improving the strength of the key 2d by arranging the opening part 22d so as to be in contact with the capstan screw 9d. Therefore, the key assembly 100d can suppress the deviation of the adjustment and further improve the reliability.

### Sixth Embodiment

The capstan screw 9e of the sixth embodiment is different from the capstan screw 9d of the fifth embodiment in that the diameter d3e of the cylinder part 18e is even smaller than the minimum diameter d2′e of the screw part 16e. The key 2e of the sixth embodiment is the same as the key 2d of the fifth embodiment. The parts that are the same as those in the first to fifth embodiments are given the same numerals as those of the previous description, and repeated descriptions will be omitted.

### [Configuration of a Fastening Points of a Capstan Screw and a Key]

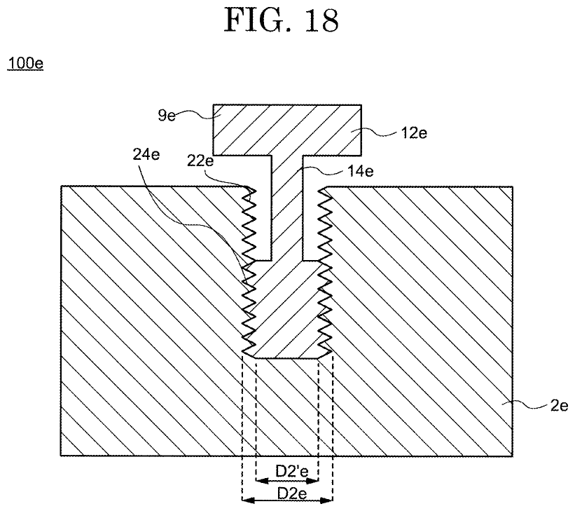

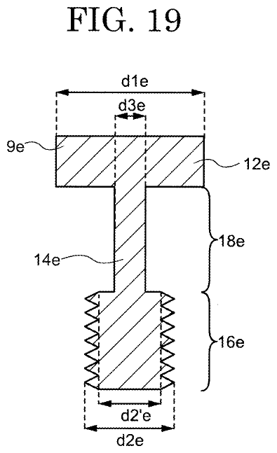

A configuration of a fastening point of a capstan screw and a key will be described in detail with reference to FIGS. 18 and 19. FIG. 18 is a partial enlarged cross-sectional view of a fastening point of the capstan screw and the key according to an embodiment of the present disclosure. FIG. 19 is a partial enlargement cross-sectional view of the capstan screw prior to fastening in one embodiment. Here, a partial enlarged top view of the fastening point of the capstan screw and the key and a partial enlarged cross-sectional view of a key prior to fastening are the same as those in the fifth embodiment, and therefore will not be described.

The capstan screw 9e has a head part 12e and a shaft part 14e. In this embodiment, the shaft part 14e has a screw part 16e and a cylinder part 18e. The screw part 16e of the capstan screw 9e is fastened to the hole part 24e of the key 2e. In FIG. 18, the screw part 16e are all placed in the hole part 24e. However, the present disclosure is not limited thereto, and a part of the screw part 16e may be arranged in the opening part 22e. In this instance, a part of the hole part 24e may have a space in which screw part 16e is not arranged. The diameter d3e of the cylinder part 18e is smaller than the maximum diameter d2e of the screw part 16e and the minimum diameter d2′e of the screw part 16e.

The key 2e includes an opening part 22e and a hole part 24e having an inner side surface for supporting the capstan screw 9e on its upper surface (the surface to be pressed). Here, the hole part 24e is arranged at the bottom of the opening part 22e. That is, the opening part 22e is arranged at the upper surface side of the key 2e with respect to the hole part 24e. The opening part 22e and the hole part 24e are continuous in the direction of rotation of the key assembly 100e. The inner side surface of the opening part 22e and the inner side surface of the hole part 24e are both arranged to surround the capstan screw 9e. Since the hole part 24e for supporting the capstan screw 9e is arranged at the bottom of the opening part 22e, the effect of the capstan screw 9e subject in the rotational directions of the key 2e due to the environmental changes and aging changes can be suppressed. The strength of the key 2e can be maintained by arranging the opening part 22e so as to surround the capstan screw 9e. Therefore, the key assembly 100e can suppress the deviation of the adjustment and maintain reliability.

In this embodiment, the diameter D1e of the opening part 22e is almost the same as the diameter D2e of the hole part 24e. Since the diameter D1e of the opening part 22e is almost the same as the diameter D2e of the hole part 24e, the strength of the key 2e can be improved. The cylinder part 18e of the capstan screw 9e is separated from the inner side surface of the opening part 22e. The diameter Die of the opening part 22e is larger than the maximum diameter d3e of the cylinder part 18e.

As described above, according to the key assembly 100e of the present embodiment, by having the hole part 24e at the bottom of the opening part 22e, the effect of the capstan screw 9e subjected in the rotational directions of the key 2e due to the environmental changes and the aging changes can be suppressed. The strength of the key 2e can be maintained by arranging the opening part 22e so as to surround the capstan screw 9e. Therefore, the key assembly 100e can suppress the deviation of the adjustment and improve reliability.

### Modified Example 1

In the first to sixth embodiments, the screw part is arranged in the hole part. The hole part 24f according to the present modified example includes a space in which the screw part 16f is not arranged. The key 2f of the present modified example is different from the key 2c of the fourth embodiment in that the hole part 24f is long. The capstan screw 9f of the present modified example is the same as the capstan screw 9c of the fourth embodiment. The parts that are the same as those of the first to sixth embodiments are given the same numerals as those of the previous description, and repeated descriptions will be omitted.

### [Configuration of a Fastening Points of a Capstan Screw and a Key]

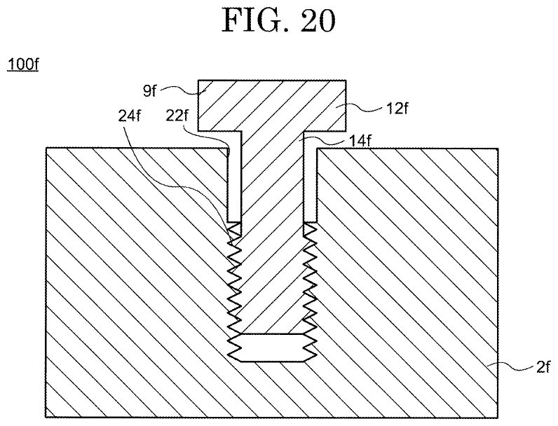

A configuration of a fastening point of a capstan screw and a key will be described in detail with reference to FIGS. 20 to 22. FIGS. 20 to 22 are partial enlargements cross-sectional view of the fastening point of the capstan screw and the key in an embodiment of the present disclosure.

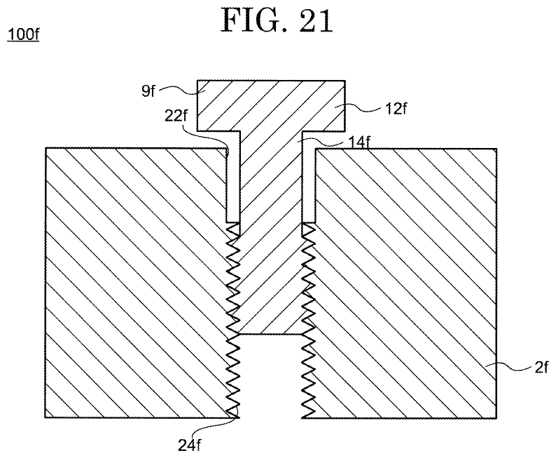

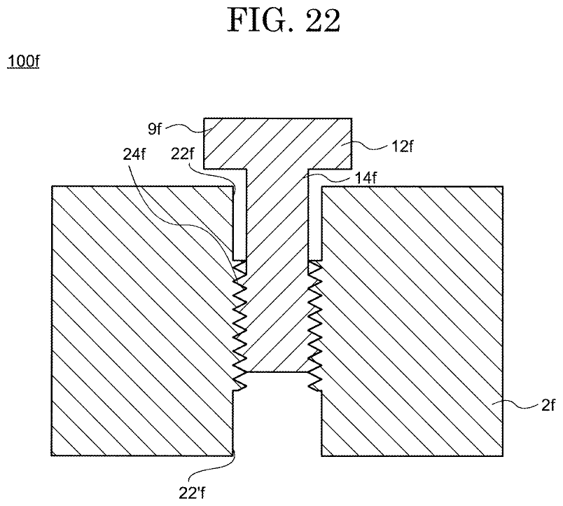

The key 2f includes an opening part 22f and a hole part 24f on its upper surface (the surface to be pressed). Here, the hole part 24f is arranged at the bottom of the opening part 22f. As shown in FIG. 20, the hole part 24f may be longer in the axial direction than the screw part 16f of the capstan screw 9f. As shown in FIG. 21, the hole part 24f may further pass through to the opposite side of the opening part 22f. As shown in FIG. 22, the hole part 24f may further continue with the second opening part 22′f in the side opposite to the opening part 22f in the rotation directions of the key assembly 100f. In FIGS. 20 to 22, capstan screw 9f is the same as the capstan screw 9c of the fourth embodiment. However, the present disclosure is not limited to this, and the screw part 16f of the capstan screw 9f may also be long.

In FIGS. 20-22, the screw part 16f is entirely arranged in the hole part 24f. In addition, a portion of the cylinder part 18f is arranged in the hole part 24f. However, the present disclosure is not limited thereto, and a part of the screw part 16f may be arranged in the opening part 22f.

As described above, according to the key assembly 100f of the present modified example, since the hole part 24f is longer in the axial direction than the screw part 16f, the capstan screw 9f can be adjusted in a wider area, and the processability of the key 2f can be improved.

### Modified Example 2

In the present embodiment, the capstan screw has a screw part, and top of the threads of the screw part and valley of the threads of the hole part, and valley of the threads of the screw part and top of the threads of the hole part are fastened so as to engage with each other. However, embodiments of the present disclosure are not limited thereto, and other fastening methods can be adapted. In this instance, the fastening forces of the inner side surface of the opening part and the capstan screw may be smaller than the fastening forces of the inner side surface of the hole part and the capstan screw.

### Modified Example 3

In the present embodiment, the keyboard assembly of the ground piano is shown as an exemplary keyboard apparatus. However, the present embodiment is not limited thereto, and the present embodiment can be applied to a keyboard apparatus having an equivalent of the capstan screw on which an equivalent of the action mechanism is mounted. An example of a keyboard apparatus may be an electronic piano, for example.

The embodiments and modified example s described above as the embodiments of the present disclosure can be appropriately combined and implemented as long as they do not contradict each other. It is also within the scope of the present disclosure to the extent that a person skilled in the art adds, deletes, or changes the designs of components as appropriate based on a key assembly of the embodiment, as long as the gist of the present disclosure is included.

What is claimed is:

1. A key assembly comprising:
a capstan; and
a key including:
an upper surface,
a hole part having a first inner side surface supporting the capstan, and an opening part arranged between the upper surface and the hole part, the opening part having a second inner side surface surrounding the capstan.

2. The key assembly according to claim 1, wherein
at least a part of the second inner side surface of the opening part and the capstan are spaced apart from each other.

3. The key assembly according to claim 1, wherein
the capstan includes a head part and a shaft part, the shaft part including a screw part, and
the screw part engages with the first inner side surface of the hole part.

4. The key assembly according to claim 3, wherein
the shaft part further includes a cylinder part between the head part and the screw part, and
a maximum diameter of the cylinder part is smaller than a maximum diameter of the screw part.

5. The key assembly according to claim 4, wherein
the maximum diameter of the cylinder part is smaller than a minimum diameter of the screw part.

6. The key assembly according to claim 4, wherein
all of the screw part is arranged in the hole part.

7. The key assembly according to claim 4, wherein
a part of the cylinder part is arranged in the hole part.

8. The key assembly according to claim 3, wherein
a maximum diameter of the head part is larger than a maximum diameter of the opening part.

9. The key assembly according to claim 1, wherein
a maximum diameter of the opening part equals a maximum diameter of the hole part.

10. The key assembly according to claim 3, wherein
a length of the hole part in an axial direction is longer than a length of the screw part in the axial direction.

11. The key assembly according to claim 1, wherein
the key further includes a lower surface such that the upper surface of the key and the lower surface of the key are opposite sides of the key across a thickness of the key, and
the hole part passes through to the lower surface of the key.

12. The key assembly according to claim 1, wherein
the key is wooden.

13. A keyboard apparatus comprising:
a key bed;
a key assembly comprising a capstan and a key, the key assembly being rotatably arranged with respect to the key bed; and
an action mechanism coupled to the capstan;
wherein the key includes:
an upper surface,
a hole part having a first inner side surface supporting the capstan, and an opening part arranged between the upper surface and the hole part, the opening part having a second inner side surface surrounding the capstan.

14. The keyboard apparatus according to claim 13, wherein
at least a part of the second inner side surface of the opening part and the capstan are spaced apart from each other.

15. The keyboard apparatus according to claim 13, wherein
the capstan includes a head part and a shaft part, the shaft part including a screw part, and
the screw part engages with the first inner side surface of the hole part.

16. The keyboard apparatus according to claim 15, wherein
the shaft part further includes a cylinder part between the head part and the screw part, and
a maximum diameter of the cylinder part is smaller than a maximum diameter of the screw part.

17. The keyboard apparatus according to claim 16, wherein
the maximum diameter of the cylinder part is smaller than a minimum diameter of the screw part.

18. The keyboard apparatus according to claim 16, wherein
all of the screw part is arranged in the hole part.

19. The keyboard apparatus according to claim 16, wherein
a part of the cylinder part is arranged in the hole part.

20. The keyboard apparatus according to claim 15, wherein
a maximum diameter of the head part is larger than a maximum diameter of the opening part.
